(19) United States
(12) Patent Application Publication
(10) Pub. No.: US 2006/0259466 A1
(43) Pub. Date: Nov. 16, 2006

(54) Updating configuration specifications in a historical database

(75) Inventor: David Bilotti, Benicia, CA (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/126,039

(22) Filed: May 10, 2005

(51) Int. Cl. G06F 17/30

(52) U.S. Cl. 707/3

(57) ABSTRACT

A data management system (102) has a memory (102B-C), and a processor (102A) coupled thereto. The processor is programmed to process (202) a change list comprising a search string and one or more items to be updated in a historical database configuration specification, search (204-210) for the historical database configuration specification according to the search string, and update (212) the historical database configuration specification according to the change list.

### FIELD OF THE INVENTION

This invention relates generally to historical tracking methods, and more particularly to updating configuration specifications in a historical database.

### BACKGROUND OF THE INVENTION

Today information management has become a crucial, if not essential, aspect to successfully conducting business. Customer Relationship Management (CRM) systems and other like applications are being used to track information relating to customers, employees, supply chain, payroll, purchase orders, and numerous other traceable items. An important function of data collection is processing reports, analyzing data organized by these reports, and taking action as a measure of continuously improving productivity, cost, quality, and overall operations of an enterprise. As data collection systems grow, the amount of information collected and the central processing resources required to process this information can be substantial.

It is quite common for enterprises to utilize an on-line system for collecting information in real-time, and an off-line system (or historical database) for extracting historical data to generate reports for analysis. The type of historical data to be extracted and recorded in the historical database is generally defined in a configuration specification. Configuration specifications can be very large for complex enterprises that collect mass amounts of data. Configuration specifications often need updating as business circumstances of an enterprise change. Because of their complexity and mere size, manual updates of configuration specifications can be prone to human error.

As such, the possibility stands that misleading reports might be provided to management from inappropriate collection of historical data due to an updated configuration specification having one or more entry errors. Such mistakes can have an adverse affect on business operations as decisions are made in reliance of the accuracy of such reports.

### SUMMARY OF THE INVENTION

Embodiments in accordance with the invention provide a method and apparatus for updating configuration specifications in a historical database.

In a first embodiment of the present invention, a computer-readable storage medium has computer instructions for processing a change list comprising a search string and one or more items to be updated in a historical database configuration specification, searching for the historical database configuration specification according to the search string, and updating the historical database configuration specification according to the change list.

In a second embodiment of the present invention, a data management system has a memory, and a processor coupled thereto. The processor is programmed to process a change list comprising a search string and one or more items to be updated in a historical database configuration specification, search for the historical database configuration specification according to the search string, and update the historical database configuration specification according to the change list.

In a third embodiment of the present invention, a method is provided in a data management system having the steps of processing a change list comprising a search string and one or more items to be updated in a historical database configuration specification, searching for the historical database configuration specification according to the search string, and updating the historical database configuration specification according to the change list.

### BRIEF DESCRIPTION OF THE DRAWINGS

FIG. 1 is block diagram of an enterprise utilizing a data management system according to an embodiment of the present invention; and

FIG. 2 depicts a flow chart of a method operating in the data management system that substantially improves the process for updating configuration specifications therein according to an embodiment of the present invention.

### DETAILED DESCRIPTION OF THE DRAWINGS

While the specification concludes with claims defining the features of embodiments of the invention that are regarded as novel, it is believed that the embodiments of the invention will be better understood from a consideration of the following description in conjunction with the figures, in which like reference numerals are carried forward.

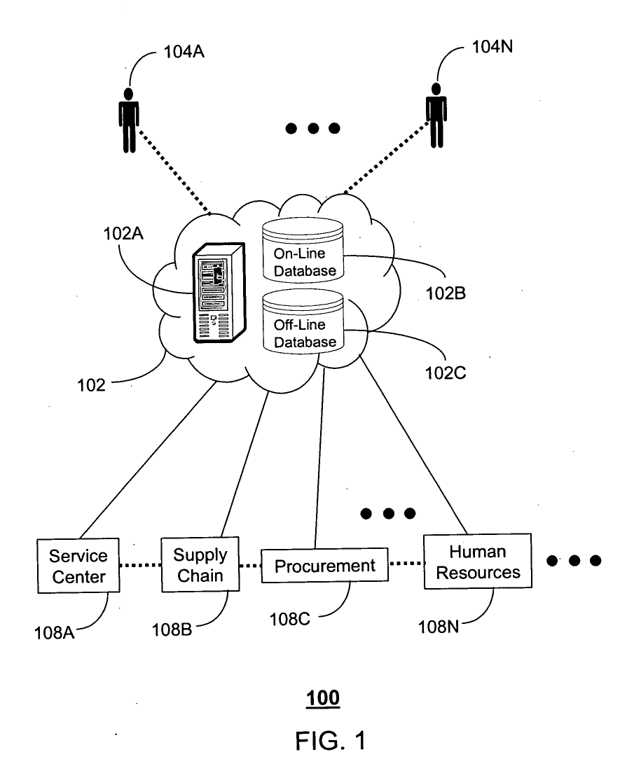

FIG. 1 is block diagram of an enterprise 100 utilizing a data management system 102 according to an embodiment of the present invention. The data management system 102 utilizes conventional technology such as a processor 102A and a memory 102B-C. The processor 102A can be one or more conventional computers or servers. The memory 102B-C utilizes a conventional media device (such as a high capacity disk drive) for storage purposes and can be used in the present application as a database for managing data collected by the enterprise. Although the processor 102A and memory 102B-C are shown separately, they can be in the alternative an integral unit. It will also be appreciated that the memory 102B-C can alternatively use other media storage types such as floppy disks, CD-ROMs, Flash memories, non-volatile ROM, and/or RAM.

The data management system 102 is coupled to a conventional communication system (not shown) such as a PSTN (Public Switched Telephone Network), IP (Internet Protocol) network, and/or a wireless communication network. The data management system 102 is coupled by way of the communication system to any number of data collection points of the enterprise 100 such as a service center 108A, supply chain 108B, procurement 108C, and human resources 108N, just to name a few.

The collection of data can be substantial, and continuous. For very large enterprises, for example, millions of collectable updates can occur on a daily basis. As such, very large conventional and replaceable memory 102B-C subsystems may be required. The data management system 102 can communicate with enterprise personnel 104A-N through conventional communication links of the communication system. Accordingly, the communication system provides the data management system 102 a means to notify analysts 104 of an event, as well as provides the analysts a means to extract, modify, and analyze information regarding the operational performance of the enterprise 100. The extraction of data from the on-line database 102B is controlled by a configuration specification as will be discussed shortly. Due to the nature of business, data collection is continuously evolving. Thus, updating configuration specifications is routine and often arduous for large enterprises that collect large amounts of information on a daily basis.

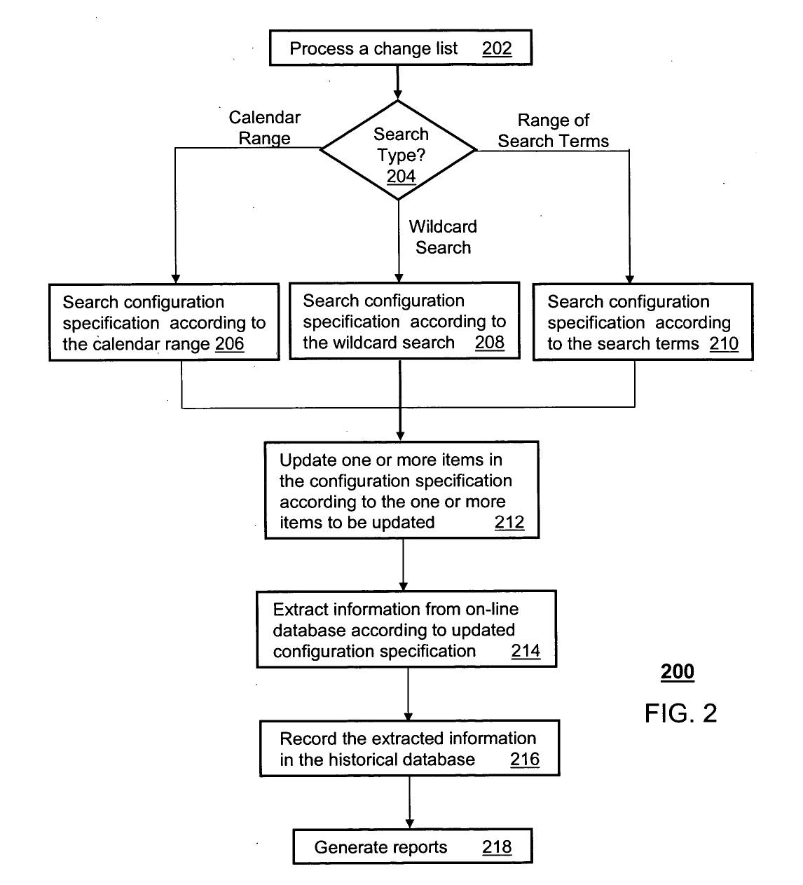

FIG. 2 depicts a flow chart of a method 200 operating in the data management system 102 that substantially improves the process of updating configuration specifications in accordance with an embodiment of the present invention. Method 200 begins with step 202 where a change list is processed by the data management system 102 for the purpose of updating a historical database configuration specification. The historical database configuration specification identifies the type of data to be extracted from the on-line database 102B and thereby recorded by the off-line database 102C (hereinafter referred to as the historical database 102C).

The change list can be created, for example, by an analyst 104 (or other enterprise personnel) for the purpose of updating the historical database configuration specification in whole or in part. The update can be motivated by a change in business circumstances, a desire to narrow or broaden the scope of data collected and analyzed, or another suitable rationalization pertinent to collection and analysis of data recorded in the on-line database 102B. To make updates, the change list includes a search string, and one or more items to be updated in the historical database configuration specification.

The search string can have numerous embodiments. FIG. 2 illustrates three embodiments. It would be obvious to an artisan with skill in the art, however, that any search string technique can be used and that the illustrations of FIG. 2 can be combined and/or modified within the scope and spirit of the claims described herein. In step 204, a determination is made as to the type of search to be performed. In a first embodiment, the search string comprises a calendar range and corresponding calendar progression update. In this embodiment, the data management system 102 proceeds to step 206 wherein a search is performed according to the calendar range.

For example, specifications for the calendar range May 1, 2005 through May 5, 2005 can be searched in the historical database configuration specification. Given that no additional search terms are provided in this example, the foregoing search can extract all specification items from the historical database configuration specification for this period. For large enterprises, the specification items retrieved can be extensive. However, where the only update desired is in updating the calendar setting of said specifications, the calendar progression update can be utilized.

The calendar progression update can perform calendar updates to the portion of the historical database configuration specification retrieved according to said period. For example, the specification portion pertaining to the calendar range of May 1, 2005 through May 5, 2005 can be updated in step 212 using the calendar progression update to advance the calendar setting for this range by a specified increment such as, for example, 5 calendar days.

Accordingly, the specification portion retrieved can be updated so that the specification information for the period of May 1, 2005 through May 5, 2005 is now applied to the period of May 6, 2005 through May 11, 2005. Consequently, after updating the historical database configuration specification in step 212, the specification information previously used for the period of May 1, 2005 through May 5, 2005 is now used for extracting information from the on-line database 102B for the period of May 6, 2005 through May 11, 2005. Other specification items within the period searched could have been identified and updated along with the calendar update in step 212. Such updating methods will be described now in steps 208 and 210.

In step 208, the historical database configuration specification can be searched by a wildcard search string. An example of this could be employees with IDs 100,0**, with salaries of $1**,***, and located in Texas. The character “*” here can represent a search for any alpha-numeric characters ranging from 0 through 9 and/or A through.Z. This string can locate specification entries for employees with IDs ranging from 100,000 through 100,099, having salaries ranging from $100,000 through $199,999, and located in Texas. Within this group, one or more items can be specified by an analyst 104 in the change list for updating purposes in step 212.

For example, the analyst 104 may want to update productivity information previously captured about these employees in the historical database 102C. Thus, the analyst 104 can include in the change list these modified specification items for updating the historical database configuration specification. Alternatively, or concurrently, the analyst 104 may desire to extract new information about these employees such as, for example, average overhead and fringe expenses that include education expenses, travel expenses, office supply expenses, medical expenses, and so on, just to mention a few. Any combination of these updates can be implemented in step 212.

Alternatively, a specific range of search terms can be included in the change list. For example, the search string of step 208 can be represented in step 210 by a search string that identifies employees by IDs ranging from 100,000 to 100,099, salaries ranging from $100,000 through $199,999, and located in Texas. It should be noted that the range in the search string need not exceed more than one item. For example, a search string can identify an employee by a single ID 100,000 and all information relating thereto.

As noted earlier, it would be obvious to an artisan with skill in the art that the forms and combinations of search strings can be innumerable. This can be illustrated in part by combining the foregoing embodiments. For example, the specification searched can range from May 1, 2005 through May 5, 2005, for employees with IDs 100,0**, with salaries ranging from $100,000 through $199,999, located in Texas, with a calendar progression update of 5 calendar days. The search results are updated in step 212 according to the change list provided by the analyst.

Once updates have been performed by the combination of steps 202-212, the data management system 102 proceeds to step 214 where information is extracted from the on-line database 102B according to the updated historical database configuration specification. The extracted information is then recorded in step 216 in the historical database 102C. In step 218, the analysts 104 (or other personnel of the enterprise 100) generate reports from the extracted information recorded in the historical database 102C for the purpose of monitoring and improving operations of the enterprise 100.

It should be noted that the on-line database 102B can operate according to any conventional software application such as, for example, a CRM (Customer Relationship Management) system supplied by vendors such as SAP, Peoplesoft, Oracle, and Microsoft, among others.

Method 200 as just described provides a substantially improved means for managing and updating historical database configuration specifications. According to said method, analysts 104 can now quickly retrieve and update said specifications with less effort and less opportunity for manual error.

It should be evident by now that the present invention can be realized in hardware, software, or a combination of hardware and software. Moreover, the present invention can be realized in a centralized fashion, or in a distributed fashion where different elements are spread across several interconnected processors. Any kind of computing device or other apparatus adapted for carrying out method 200 described above is suitable for the present invention.

Additionally, the present invention can be embedded in a computer program product, which comprises all the features enabling the implementation of method 200, and which when loaded in a computer system is able to carry out these methods as computer instructions. A computer program in the present context means any expression, in any language, code or notation, of a set of instructions intended to cause a system having an information processing capability to perform a particular function either directly or after either or both of the following: a) conversion to another language, code or notation; b) reproduction in a different material form. It should be also evident that the present invention may be used for many applications. Thus, although the description is made for particular arrangements and methods, the intent and concept of the invention is suitable and applicable to other arrangements and applications not described herein. As noted earlier, method 200 can utilize any search term technique. Moreover, any improvements to the change list for identifying specification items and modifications thereof are considered to be within the scope of the claimed invention. It would be clear therefore to those skilled in the art that there are many potential modifications that can be effected on the disclosed embodiments without departing from the spirit and scope of the invention.

Accordingly, the described embodiments ought to be construed to be merely illustrative of some of the more prominent features and applications of the invention. It should also be understood that the claims are intended to cover the structures described herein as performing the recited function and not only structural equivalents. Therefore, equivalent structures that read on the description should also be construed to be inclusive of the scope of the invention as defined in the following claims. Thus, reference should be made to the following claims, rather than to the foregoing specification, as indicating the scope of the invention.

What is claimed is:

1. A computer-readable storage medium, the storage medium comprising computer instructions for:
processing a change list comprising a search string and one or more items to be updated in a historical database configuration specification;
searching for the historical database configuration specification according to the search string; and
updating the historical database configuration specification according to the change list.

2. The storage medium of claim 1, wherein the search string comprises a calendar range and a calendar progression update, and wherein the storage medium further comprises computer instructions for:
searching the historical database configuration specification according to the calendar range; and
updating the historical database configuration specification according to the calendar progression update.

3. The storage medium of claim 2, further comprising computer instructions for updating the historical database configuration specification according to the one or more items to be updated.

4. The storage medium of claim 1, wherein the search string comprises one or more wildcard search terms, and wherein the storage medium further comprises computer instructions for:
searching the historical database configuration specification according to the one or more wildcard search terms; and
updating the historical database configuration specification according to the one or more items to be updated.

5. The storage medium of claim 1, wherein the search string comprises a range of one or more search terms, and wherein the storage medium further comprises computer instructions for:
searching the historical database configuration specification according to the range of one or more search terms; and
updating the historical database configuration specification according to the one or more items to be updated.

6. The storage medium of claim 1, further comprising computer instructions for:
extracting information from an on-line database according to the updated historical database configuration specification; and
recording the extracted information in a historical database.

7. The storage medium of claim 6, further comprising computer instructions for generating one or more reports from the extracted information recorded in the historical database.

8. A data management system, comprising:
a memory; and
a processor coupled to the memory, wherein the processor is programmed to:
process a change list comprising a search string and one or more items to be updated in a historical database configuration specification;
search for the historical database configuration specification according to the search string; and
update the historical database configuration specification according to the change list.

9. The data management system of claim 8, wherein the search string comprises a calendar range and a calendar progression update, and wherein the processor is programmed to:
search the historical database configuration specification according to the calendar range; and
update the historical database configuration specification according to the calendar progression update.

10. The data management system of claim 9, wherein the processor is further programmed to update the historical database configuration specification according to the one or more items to be updated.

11. The data management system of claim 8, wherein the search string comprises one or more wildcard search terms, and wherein the processor is programmed to:
search the historical database configuration specification according to the one or more wildcard search terms; and
update the historical database configuration specification according to the one or more items to be updated.

12. The data management system of claim 8, wherein the search string comprises a range of one or more search terms, and wherein the processor is programmed to:
search the historical database configuration specification according to the range of one or more search terms; and
update the historical database configuration specification according to the one or more items to be updated.

13. The data management system of claim 8, wherein the processor is programmed to:
extract information from an on-line database according to the updated historical database configuration specification; and
record the extracted information in a historical database.

14. The data management system of claim 13, wherein the processor is programmed to generating one or more reports from the extracted information recorded in the historical database.

15. A method in a data management system, comprising the steps of:
processing a change list comprising a search string and one or more items to be updated in a historical database configuration specification;
searching for the historical database configuration specification according to the search string; and
updating the historical database configuration specification according to the change list.

16. The method of claim 15, wherein the search string comprises a calendar range and a calendar progression update, and wherein the method comprises the steps of:
searching the historical database configuration specification according to the calendar range; and
updating the historical database configuration specification according to the calendar progression update.

17. The method of claim 16, further comprising the step of updating the historical database configuration specification according to the one or more items to be updated.

18. The method of claim 16, wherein the search string comprises one or more wildcard search terms, and wherein the method comprises the steps of:
searching the historical database configuration specification according to the one or more wildcard search terms; and
updating the historical database configuration specification according to the one or more items to be updated.

19. The method of claim 16, wherein the search string comprises a range of one or more search terms, and wherein the method comprises the steps of:
searching the historical database configuration specification according to the range of one or more search terms; and
updating the historical database configuration specification according to the one or more items to be updated.

20. The method of claim 16, comprising the steps of:
extracting information from an on-line database according to the updated historical database configuration specification; and
recording the extracted information in a historical database.
